(19) United States
(12) Patent Application Publication
(10) Pub. No.: US 2003/0020248 A1
(43) Pub. Date: Jan. 30, 2003

(54) Inflatable tube ski vehicle with steering mechanism

(76) Inventor: Barry G. Oberpriller, Leverett, MA (US)

Correspondence Address: John A. Kramer, 171 Dwight Road, Longmeadow, MA, 01106-1700, US

(21) Appl. No.: 09/991,011

(22) Filed: Nov. 14, 2001

Related U.S. Application Data
(63) Continuation-in-part of application No. 09/915,037, filed on Jul. 25, 2001.

(51) Int. Cl. B62B 9/04

(52) U.S. Cl. 280/21.1; 280/18.1

(57) ABSTRACT

An inflatable tube ski vehicle with steering mechanism comprises an inflated, torus- or delta-shaped tube or bladder and a ski insert disposed in the central opening of the bladder. The ski insert may be dish-shaped, or it may partially wrap around the top and/or bottom of the bladder. In either case, the ski vehicle has a steering/braking mechanism comprising left and right lever arms pivotally attached to and extending down through the ski insert. To turn, a rider simply pulls on one of the lever arms, causing a lower portion of the lever arm to extend past a bottom of the insert. To brake, both arms are pulled simultaneously. Because the ski vehicle is generally round and because the weight of the vehicle and rider are largely uniformly distributed over the center of the vehicle, a pivot or fulcrum point occurs directly under the rider's seat, affording a significant degree of control.

This is a continuation-in-part of U.S. patent application Ser. No. 09/915,037, filed Jul. 25, 2001.

### FIELD OF THE INVENTION

The present invention relates to devices for traveling in snow or water, and, more particularly, to un-powered devices for traveling down snow-covered slopes or behind boats.

### BACKGROUND OF THE INVENTION

Where possible, e.g., in the northern latitudes, humans have long exploited the recreational possibilities of winter. Frozen ponds mean ice fishing, hockey, and ice skating. Snow covered trails mean snowmobiling and cross-country skiing. And snow covered slopes mean downhill skiing, snowboarding, tubing, and sledding. In fact, formal facilities (e.g., groomed slopes, chair lifts) for the latter have become so numerous in recent years that the opportunities for conveniently and inexpensively engaging in downhill winter sports have increased to unprecedented levels.

Unfortunately, however, many people either cannot or do not take part in downhill winter sports. This is because the sports oftentimes require expensive equipment, a high degree of skill, or both, and can be quite dangerous. Rental equipment may ease the bother of the former, but the latter two always remain a problem. Skiing, for example, can take years to learn well, and there are all too many unfortunate examples of fatal or debilitating accidents on the slopes.

Accordingly, many alternatives to the more skill-oriented and dangerous downhill winter sports have been proposed over the years. These have primarily taken the form of small, “gravity powered” vehicles such as sleds and inflated tubes. In particular, the latter have become quite popular at ski resorts, and basically mirror the idea of the simple sled: a person, sitting or lying on a tube, slides down a snow-covered hill in a straight path and in a more-or-less uncontrolled manner. Tubing is fun and economical, but suffers from a lack of directional control that makes it rather unappealing for those seeking a more “interactive,” skiing-like experience. Additionally, this lack of control causes problems at resorts or other ski facilities. For example, tube runs must be properly groomed to ensure that people traveling downhill on the tubes go in the right direction, and resort personnel must be stationed at the top of the run to ensure that only one person goes down at a time (because the people using the tubes have no control and can only travel, more-or-less, in a straight line downhill).

Recognizing these problems, many “steerable” sleds have been proposed over the years. For example, U.S. Pat. No. 3,366,395 to Bjork (“Bjork”) shows a three-runner sled whose single front runner can be turned via a pair of handlebars, and U.S. Design Pat. No. 316,234 to Mirisch, Sr. (“Mirisch, Sr.”) shows a tray-like sled having a front steering member operated by a person's feet. Although these designs are theoretically functional, they demonstrate why steerable sleds have never really caught on in the marketplace. More specifically, many sleds simply do not work that well in varied snow conditions. For example, sleds with deep, blade-like runners, like the one in Bjork, are almost useless in loose powder conditions. Likewise, tray-like sleds, like the one in Mirisch, Sr., are only useful on packed slopes or trails. Additionally, even if these steerable sleds function in certain snow conditions, they rarely, if ever, provide an optimum, ski-like level of control. Typically, a user can only change the sled's general direction of travel, cannot make hard left or right turns, and has no effective means for braking. Further, many sleds can be heavy or awkward, making them impractical for use at ski facilities with chair lifts.

Accordingly, a primary object of the present invention is to provide an un-powered ski vehicle that operates well and is highly maneuverable in most snow conditions.

Another primary object of the present invention is to provide an un-powered ski vehicle that is compatible with chair lifts.

An additional primary object of the present invention is to provide an un-powered ski vehicle that has an effective braking mechanism.

### SUMMARY OF THE INVENTION

An inflatable tube ski vehicle with steering mechanism comprises an air-inflated, torus- or delta-shaped tube or bladder and a ski insert positioned in the bladder's central opening. The ski insert can be dish-shaped, in which case it is attached to the underside of the bladder by way of straps or other mechanical fasteners. Alternatively, the ski insert can be contoured to partially wrap around the top and bottom of the bladder, like a tire rim, such that the ski insert is effectively attached to the bladder by way of an air lock seal. In either case, the ski vehicle is provided with a steering/braking mechanism comprising left and right, generally L-shaped lever arms pivotally attached to the ski insert near their midpoints. The lever arms pass through left and right side slots or openings provided in the ski insert, such that upper portions of the lever arms lie generally above the top of the ski insert, while lower portions of the lever arms lie below the top of the ski insert. Handles are attached to upper ends of the lever arms, while snow rakes, shaped for engaging snow, are attached to lower ends of the lever arms. The lever arms can be moved from a retracted position, wherein the snow rakes lie generally tucked up into the side slots, and to a deployed position, wherein the snow rakes extend significantly beyond the bottom of the ski insert for engaging snow. Also, two parallel runners are attached to the bottom of the ski insert.

To use the ski vehicle, a rider sits in the ski insert and draped over the bladder, with the rider's legs extending over the front of the vehicle. In this position, the rider can grasp the handles and travel downhill. With the lever arms in their retracted position, the snow rakes do not interfere with passing snow, and the vehicle travels straight downhill, as facilitated by the runners. To turn left or right, the rider simply pulls on the left or right lever arm, respectively, causing the applicable snow rake to extend down into the snow. To brake, both arms are pulled simultaneously. The harder the rider pulls on either lever arm alone (for steering), or both lever arms together (for braking), the more aggressively the vehicle turns or slows down, as applicable. Because the ski vehicle is generally round and the weight of the vehicle and rider are largely uniformly distributed over the center of the vehicle, and because the lever arms extend down through the central opening of the bladder, a pivot or fulcrum point occurs directly under the rider's seat, allowing the ski vehicle to make relatively tight turns.

### BRIEF DESCRIPTION OF THE DRAWINGS

These and other features, aspects, and advantages of the present invention will become better understood with respect to the following description, appended claims, and accompanying drawings, in which:

FIG. 1 is a front cross-sectional view of an inflatable tube ski vehicle with steering mechanism according to the present invention;

FIG. 2 is a side cross-sectional view of the inflatable tube ski vehicle;

FIG. 3 is a top plan view of the inflatable tube ski vehicle;

FIG. 4 is a bottom plan view of the inflatable tube ski vehicle;

FIGS. 5A & 5B are partial cross-sectional views of the inflatable tube ski vehicle showing different means for attaching a bladder portion of the ski vehicle to a ski insert portion of the ski vehicle;

FIGS. 6A-6E are top and bottom plan views and front and side cross-sectional views, respectively, of the inflatable tube ski vehicle with an alternative ski insert;

FIG. 7 is a cross-sectional view of an alternative steering mechanism; and

FIGS. 8A & 8B are top plan views of the ski vehicle with delta-shaped bladders.

### DETAILED DESCRIPTION OF THE INVENTION

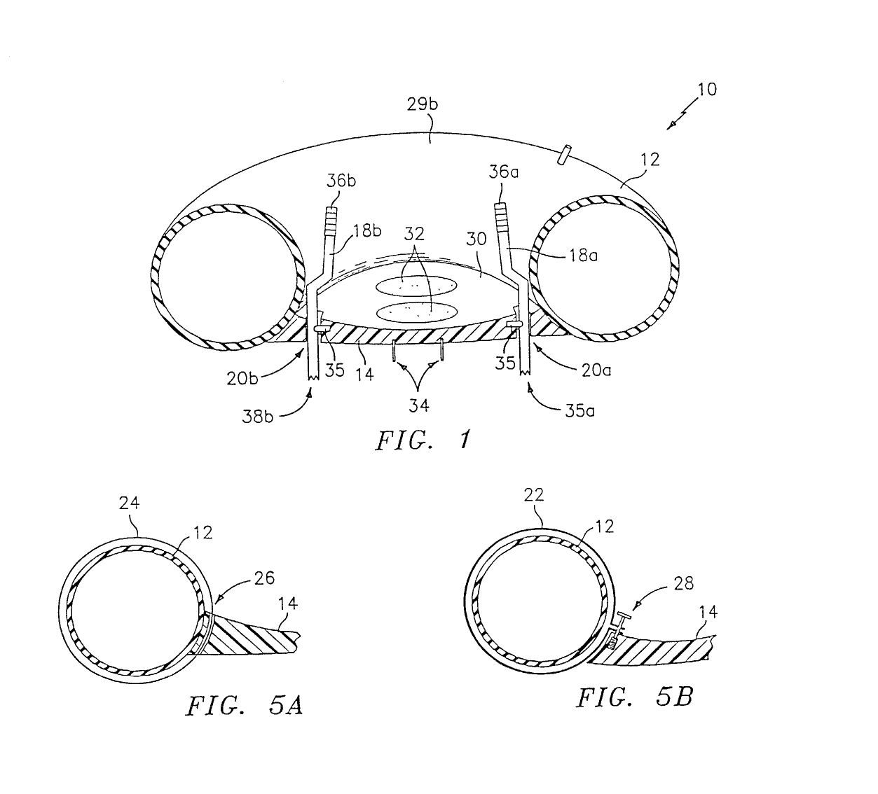

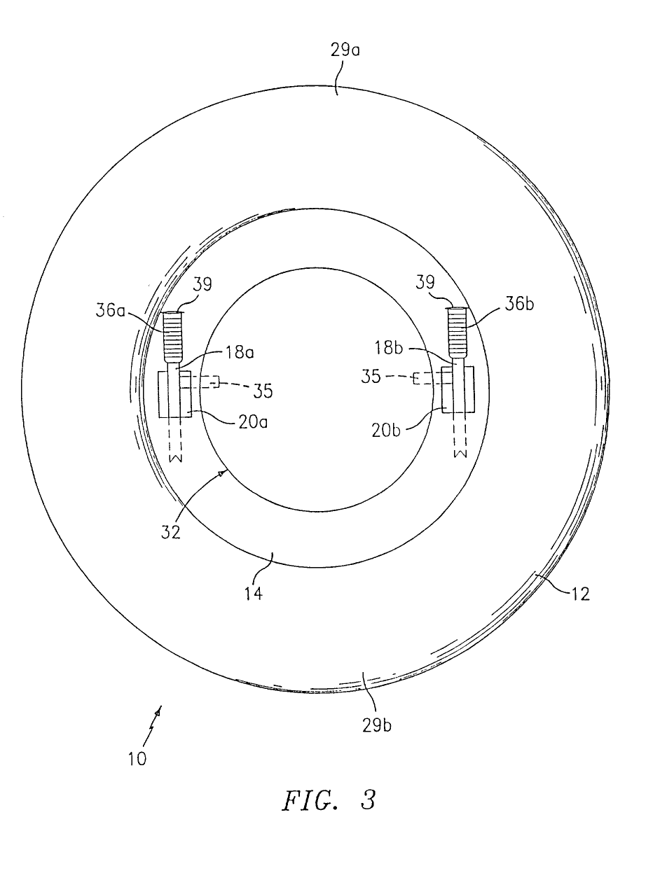

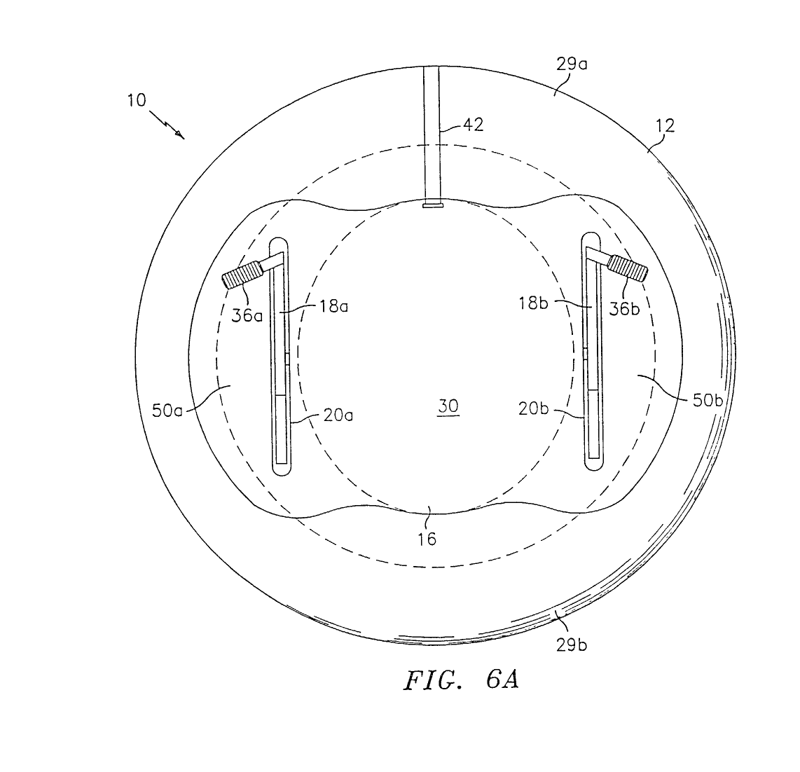

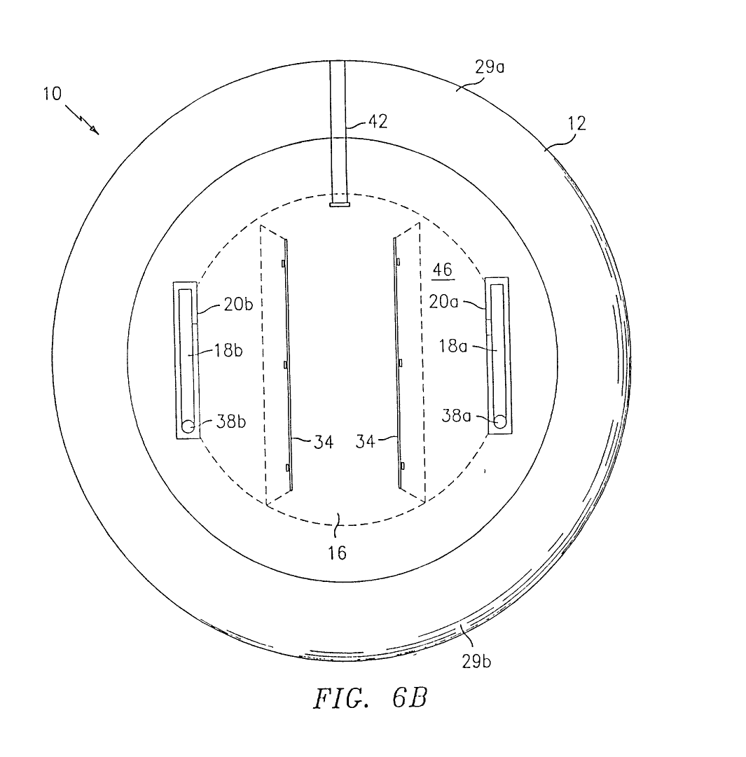

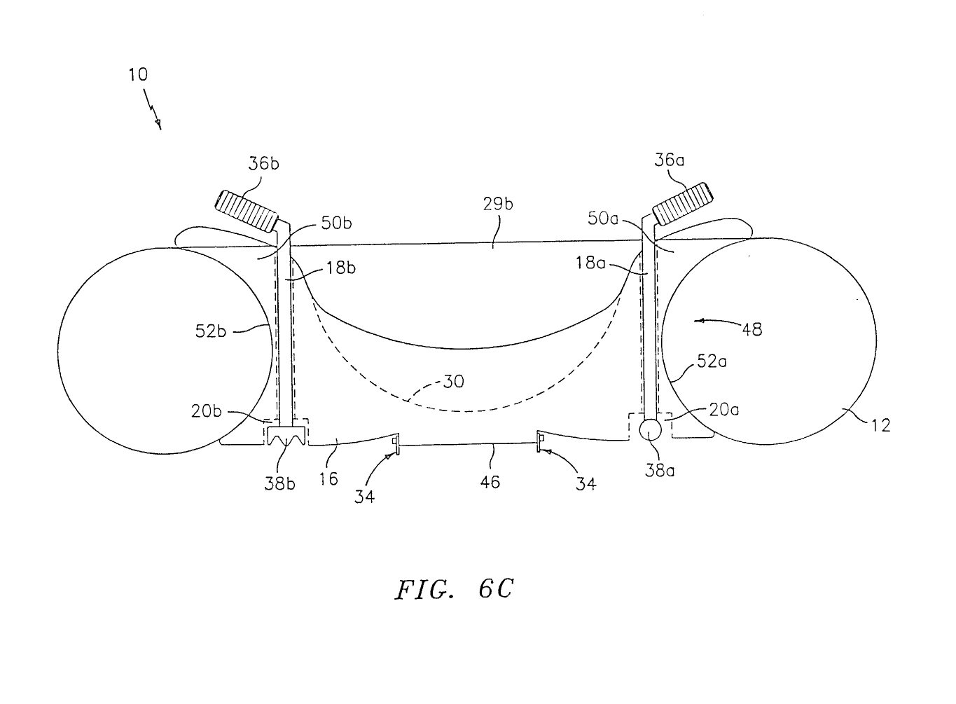

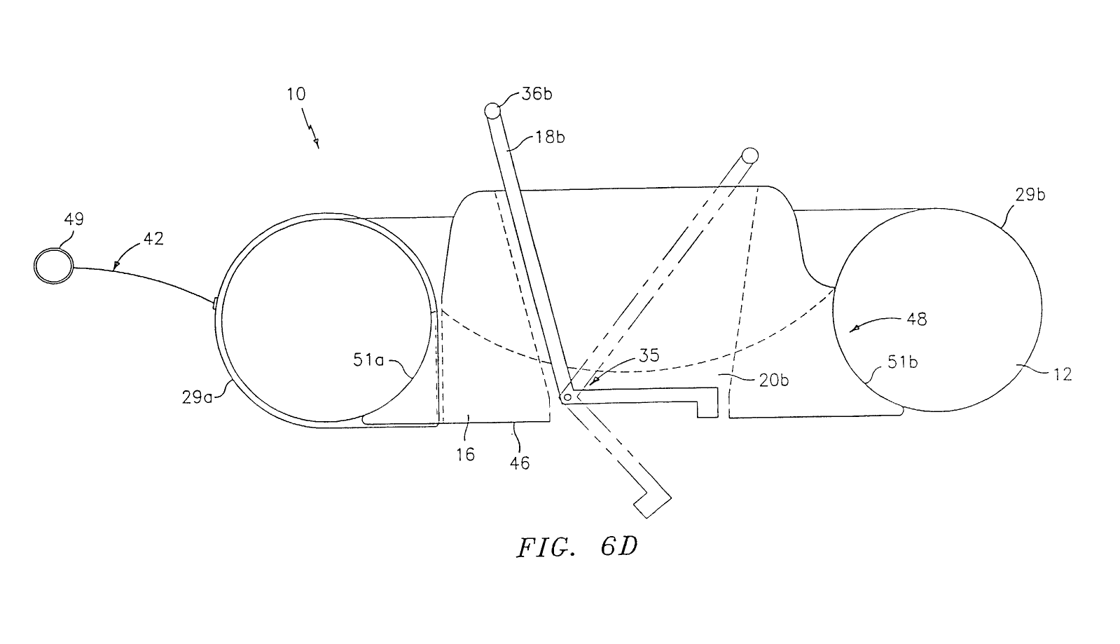

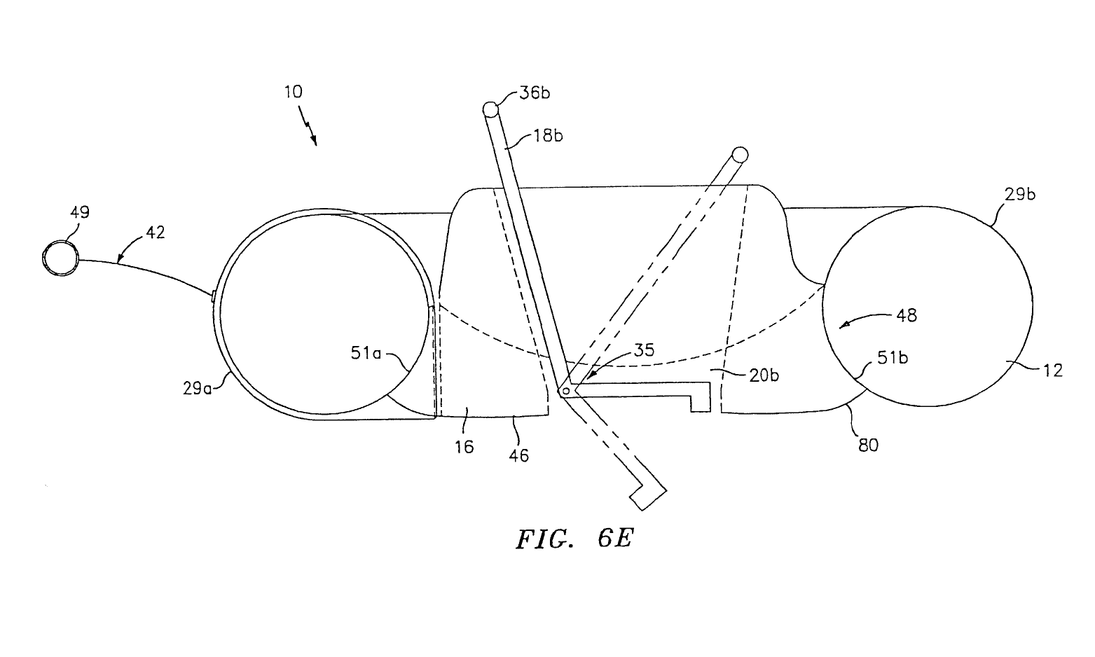

With reference to FIGS. 1-6E, an inflatable tube ski vehicle with steering mechanism 10 comprises a standard, air-inflated, torus-shaped tube or bladder 12 and a ski insert 14 or 16 disposed in the central opening of the bladder (as discussed below, the bladder can have other shapes as well). The ski insert can be a dish-shaped ski insert 14 attached to the underside of the bladder 12 and partially extending up into the bladder's central opening. Alternatively, a contoured ski insert 16 that partially wraps around the top and bottom of the bladder 12, as shown in FIGS. 6A-6D, may be used. In either case, the ski vehicle 10 is provided with a steering/braking mechanism comprising left and right lever arms 18a, 18b pivotally attached to the ski insert 14, 16. The lever arms 18a, 18b respectively pass through left and right side openings or slots 20a, 20b that extend through the ski insert. To turn left or right, a rider simply pulls on the left or right lever arm 18a, 18b, respectively, causing a lower portion of the arm to extend into the snow. To brake, both arms 18a, 18b are pulled simultaneously. The harder the rider pulls on either lever arm alone (for steering), or both lever arms together (for braking), the more aggressively the ski vehicle turns or slows down, as applicable. Because the ski vehicle is round and the weight of the vehicle and rider are largely uniformly distributed over the center of the vehicle, and because the lever arms extend down through the central opening of the bladder, a pivot or fulcrum point occurs directly under the rider's seat, providing a significant degree of control.

FIGS. 1-5B show the inflatable tube ski vehicle 10 with the bladder 12 and dish-shaped (e.g., generally round and thin) ski insert 14. The bladder 12, as mentioned, is a standard, air-inflated, torus-shaped tube having a central opening or aperture. The bladder 12 gives the ski vehicle 10 a significant portion of its mass, which in turn provides anti-tipping stability. The bladder 12 also provides a comfortable support for the rider's body, and increases the vehicle's snow buoyancy and speed by providing the ski vehicle with a large, low friction footprint. The bladder 12 can be covered with a protective cover 22 (see FIG. 5B), and can be attached to the dish-shaped ski insert 14 via a plurality of straps 24 extending around the bladder 12 and through holes 26 provided in the ski insert 14 (see FIG. 5A), or via the cover 22 being affixed to the ski insert 14 via bolts 28 or the like. Once the ski insert 14 is affixed to the bladder 12, a front 29a and a rear 29b of the ski vehicle are effectively defined.

The dish-shaped ski insert 14 is round and has a generally flat bottom. It is made of polyethylene, polyvinyl chloride, polystyrene, or any other strong, light, thermoplastic or polymer material. The ski insert 14 can be injection molded, roto-molded, or otherwise, according to standard manufacturing methods. The ski insert 14 acts as a “keystone” by holding the operational parts of the ski vehicle together, and as a means for attaching the steering mechanism (lever arms 18a, 18b) to the bladder 12. The ski insert 14 also comprises a goodly portion of the ski vehicle's bottom, providing the vehicle with a low friction, buoyant sliding surface.

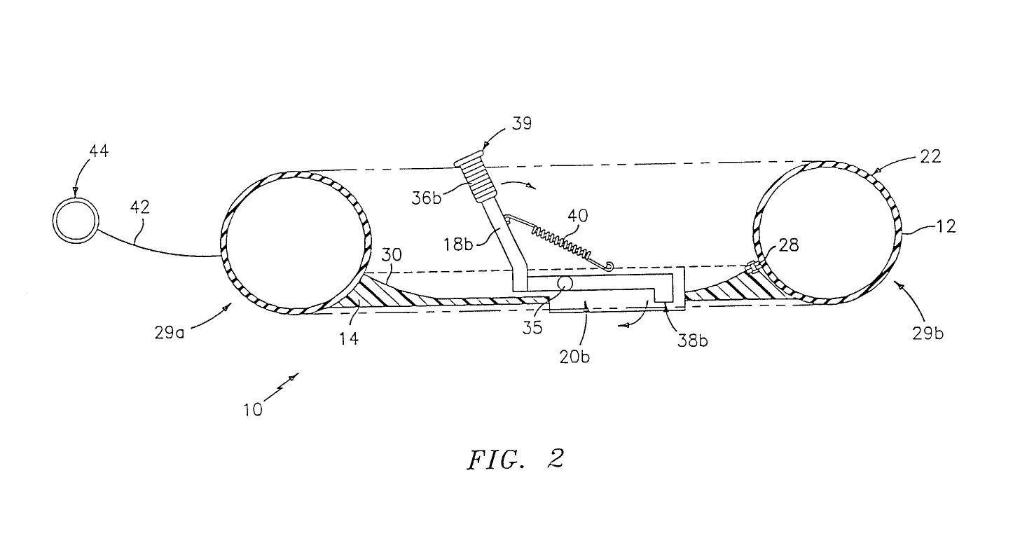

The ski insert 14 abuts the bottom area of the central opening of the bladder 12, and may come flush to the very bottom of the bladder 12; alternatively, it may lie slightly recessed within the confines of the bladder's central opening, as best seen in FIGS. 1 and 2. A concave top surface 30 of the ski insert 14 is optionally provided with one or more cushions 32, and serves as a seat or cockpit. Also, the ski insert 14 has the two slots 20a, 20b disposed therein, on either side of the ski insert. The slots extend through the ski insert from top to bottom, and may have elongated, recessed bottom portions, as shown in FIGS. 2 and 6D, for accommodating the snow rakes and lower portions of the lever arms when retracted (as shown in FIG. 2).

Additionally, the generally flat underside of the ski insert is provided with two parallel runners 34 composed of metal, plastic, or any other hard material. The runners 34 are mounted to the center underside of the ski insert 14, and provide the ski vehicle with directional stability. More specifically, without the runners, the ski vehicle 10 would potentially slide and spin out of control. However, with the runners 34, once a rider chooses a path or direction of travel by using the lever arms 18a or 18b, the runners help ensure that the vehicle continues along that path without much further effort by the rider. The ski vehicle effectively steers itself until the rider again operates one of the lever arms 18a, 18b.

As mentioned, the ski vehicle 10 is provided with the steering/braking mechanism comprising the two lever arms 18a, 18b pivotally attached to the ski insert 14 and passing through the slots 20a, 20b in the ski insert 14. The lever arms are pivotally attached to the ski insert at their midpoints, or at some other point between the ends of the lever arms, by way of pivot shafts 35 or the like. The lever arms 18a, 18b are bent according to a modified L-shape, as best seen in FIGS. 2 and 6D. Upper ends of the lever arms 18a, 18b are provided with handles 36a, 36b, respectively, while lower ends of the arms, pivotal beyond the bottom of the ski insert 14, are provided with snow rakes 38a, 38b, e.g., contoured ends for engaging snow. The handles 36a, 36b may be contoured or provided with top discs or extensions 39 for preventing a rider's hands from slipping off the handles. The handles 36a, 36b may be positioned co-axial with the lever arms, or they may be disposed perpendicularly (or at another angle) with respect thereto.

The lever arms 18a, 18b can be moved from a retracted position, as shown in FIG. 2, to a fully deployed position as shown in FIG. 1. When the arms are retracted, the snow rakes 38a, 38b lie generally tucked up into the slots 20a, 20b, with the handles 36a, 36b being located further towards the front of the vehicle. When deployed, as shown in FIG. 1, via a rider grasping the handles 36a, 36b and pulling rearwards, the snow rakes extend significantly beyond the bottom of the ski insert 14, so as to engage snow. Alternatively, the arms and snow rakes can be configured to extend slightly beyond the bottom of the ski vehicle when fully retracted, or to lie pressed up against the bottom of the ski vehicle. This might slow the vehicle slightly, but will not interfere with steering or control, and may be helpful in accommodating variances in insert design.

The lever arms 18a, 18b and associated snow rakes 38a, 38b are what give a rider operational control over the ski vehicle 10. When the lever arms 18a, 18b are pulled, the snow rakes 38a, 38b are forced into the snow, causing drag. The amount of drag is directly proportional to the amount of force applied to the lever(s), i e., the harder the rider pulls on one of the levers, the more drag the ski vehicle experiences on that side. Because the ski vehicle is round in shape and the weight of the vehicle and rider are largely uniformly distributed over the center of the vehicle, and because the lever arms extend down through the bladder's central opening, a pivot or fulcrum point occurs directly under the rider's seat. When the rider delivers drag to the left or right side of the ski vehicle, by way of the lever arms 18a, 18b, the vehicle turns or pivots on its center, and the vehicle rotates in the direction of the drag (left or right). If the rider pulls back on both lever arms 18a, 18b at the same time, creating drag on both sides of the ski vehicle, the ski vehicle does not rotate or turn; rather, it simply slows down and/or stops. As should be appreciated, since the ski vehicle 10 pivots or turns over its center, a rider can make very tight turns, thereby achieving ski-like control.

To use the ski vehicle 10, a rider sits in the ski insert 14 and draped over the bladder 12, with the rider's legs extending over the front 29a of the vehicle, e.g., as if reclined in an easy chair or recliner. In this position, the bladder 12 supports the rider's legs and back, and the user can grasp the handles 36a, 36b and travel downhill. With the lever arms 18a, 18b in the retracted position, the snow rakes 38a, 38b do not interfere with passing snow, and the vehicle travels straight downhill, as facilitated by the runners 34. To turn, one of the arms 18a, 18b is deployed or partially deployed by pulling rearwards on the appropriate handle 36a or 36b. This causes the lower portion of the particular arm, including its snow rake 38a or 38b, to extend down into the snow, causing drag, and, thereby, the ski vehicle 10 to turn. The degree to which one of the arms 18a, 18b is pulled rearwards will determine the sharpness of the turn. To brake, the rider pulls rearwards on both handles, causing both snow rakes 38a, 38b to pivot downwards into the snow, and the vehicle to slow or stop.

As a safety precaution, the arms 18a, 18b may be provided with extension springs 40 (see FIG. 2), which tend to pull the arms slightly rearwards. This causes the snow rakes 38a, 38b to be normally partially extended, so that if the ski vehicle gets away from the rider (e.g., the rider falls off the vehicle), the vehicle will come to a stop by way of the springs 40 causing the snow rakes 38a, 38b to engage the passing snow. During use, the rider maintains a slight forward bias on the arms 18a, 18b, against the action of the springs 40, if the rider wants to travel at full speed.

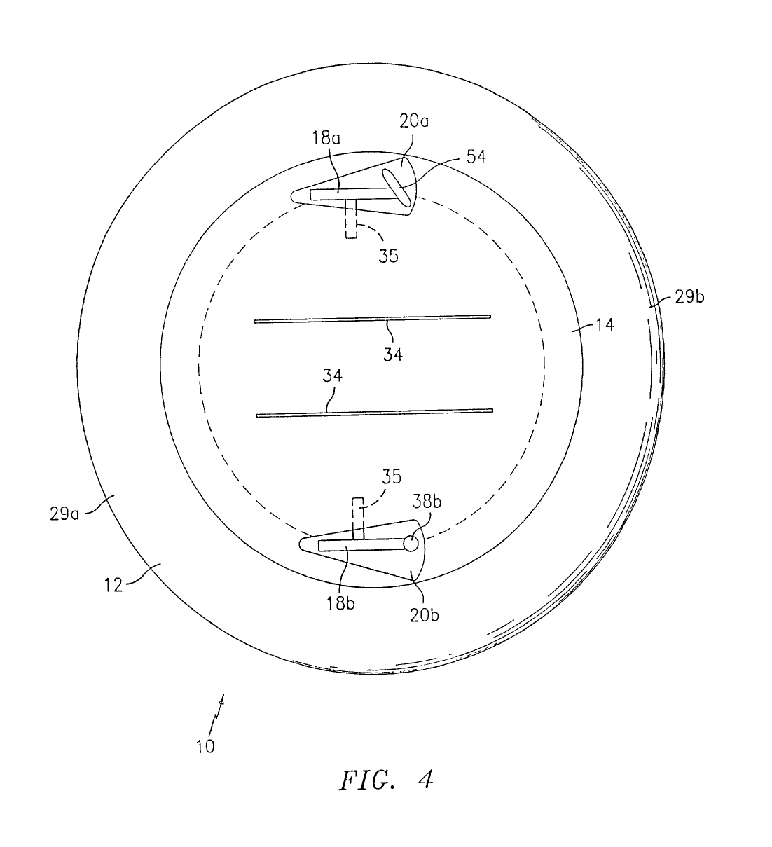

The snow rakes 38a, 38b can be of many different designs, such as serrated rakes as shown in FIG. 1, round or scoop-like rakes as shown in FIGS. 2 and 4, or shortened ski-like rakes.

As shown in FIGS. 2, 6A, 6B, and 6D, the ski vehicle 10 may be provided with a tow line or strap 42 and rubber ring 44 for facilitating towing the ski vehicle up a ski slope, behind a boat, or otherwise.

FIGS. 6A-6D show the inflatable tube ski vehicle 10 with the bladder 12 and the contoured ski insert 16. The contoured insert 16 will typically be hollow (for reducing weight), and can be made of any light, strong material, such as plastic, by way of conventional manufacturing processes. The contoured insert 16 performs the same function as the dish-shaped insert 14, and thus is generally similar to the dish-shaped insert 14, e.g., it defines a seat area 30, as well as the side openings or slots 20a, 20b.

The contoured ski insert 16 comprises a round, generally flat bottom 46 that is flush with the bottom of the bladder 12, or slightly set back therefrom. From the bottom 46, the ski insert 16 extends up into the central opening of the bladder 12, generally conforming to the shape of the bladder 12. More specifically, the ski insert 16 has an annular, outwardly facing, concave side wall 48 that is shaped to fit against the bladder 12, as shown in FIGS. 6A and 6C. Additionally, instead of lying entirely within the confines of the bladder's central opening, the contoured insert 16 has two “wings” 50a, 50b that extend partially up over opposite top sides of the bladder 12. With the wings 50a, 50b, the side wall 48 effectively comprises forward and rear portions 51a, 51b that extend part-ways up the bladder 12, and left and right side portions 52a, 52b that extend up over the top of the bladder 12. In this manner, the bladder 12 is held in place against the side wall 48 by the wings 50a, 50b, and the contoured ski insert 16 effectively acts as a tire rim, with the bladder 12 becoming air locked to the contoured ski insert 16 when inflated. Thus, the bladder 12, with or without a cover 22, is connected to the ski insert 16 without the use of mechanical fasteners.

Instead of having a generally flat bottom, as shown in FIG. 6D, the contoured insert 16 (or the dish-shaped ski insert 14, for that matter) can be provided with a bottom 46 whose outer annular edge portion 80 is rounded upwards, as shown in FIG. 6E. This reduces the likelihood of snow becoming lodged between the insert 16 and the bladder 12.

FIGS. 1, 6B, and 6C show how the runners 34 may be affixed to the ski inserts 14, 16. In particular, the runners 34 may be molded or press fit into the ski insert, as shown in FIG. 1, or they may be bolted to the ski insert, as shown in FIGS. 6B and 6C. For the latter, the ski insert may be provided with threaded female sockets (not shown) disposed in the ski insert at appropriate locations during, e.g., a molding process. Other conventional attachment means are also possible. Also, as shown in FIG. 6C, the bottom 46 of the ski insert may be contoured, concave-shaped, or otherwise, to accommodate the runners 34.

Since the ski vehicle is relatively light and includes the buoyant, inflated bladder 12, the ski vehicle 10 can be towed behind a boat or otherwise used in the water. For use in water, the tow line or strap 42 (or some other kind of tow harness) is attached to the vehicle, and the ski vehicle is towed behind a boat. The ski vehicle is the same as described above, except that instead of snow rakes 38a, 38b, the ends of the lever arms 18a, 18b are provided with steering fins 54, as shown in FIG. 4. When the vehicle is pulled behind a boat, the lever arms 18a, 18b can be used to steer the vehicle by appropriately extending or retracting the fins 50.

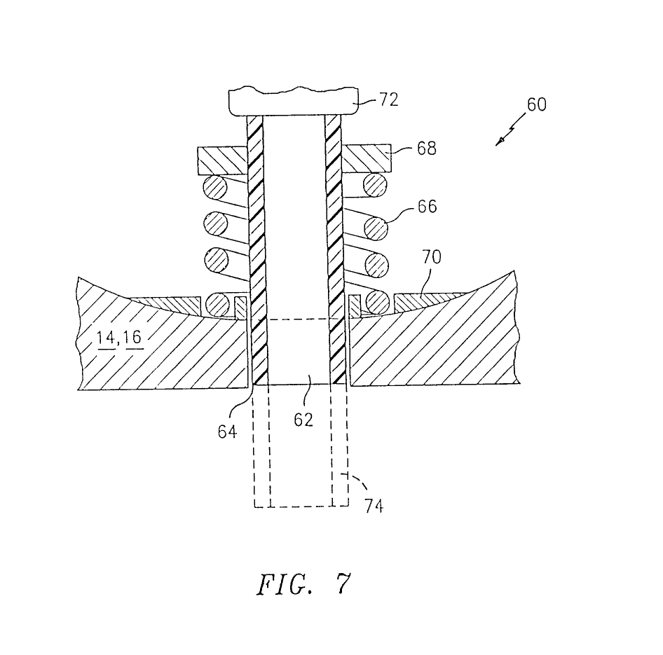

While the ski vehicle 10 has been shown as having the two, generally L-shaped lever arms 18a, 18b pivotally attached to the ski insert 14, 16, other types of steering/braking arms could be used instead. FIG. 7, for example, shows a push-actuated lever arm 60. The push-actuated lever arm 60 comprises a shaft 62 disposed in an opening 64 provided in the ski insert 14, 16, and a compression spring 66 positioned concentrically over the shaft 62 and between the top of the ski insert 14, 16 and a retaining collar 68 attached to the shaft 62. The spring 66 may also be held in place by way of a retaining element 70 attached to the ski insert. The top end of the shaft 62 is provided with a handle 72. To use the push-actuated lever arms 60 for steering or braking (e.g., in a vehicle equipped with two of the push-actuated lever arms 60 in place of the pivoting lever arms 18a, 18b) a rider simply pushes down on one of the handles 72 for steering, and on both of the handles simultaneously for braking. More specifically, pushing down on the handle 72 causes the shaft 62 to extend beyond the bottom of the ski insert 14, 16, as indicated at position 74 in FIG. 7, which causes drag, and the ski vehicle to turn or slow down. As should be appreciated, the push-actuated lever arm 60 could be positioned at an angle with respect to the ski insert, instead of vertically as shown in FIG. 7.

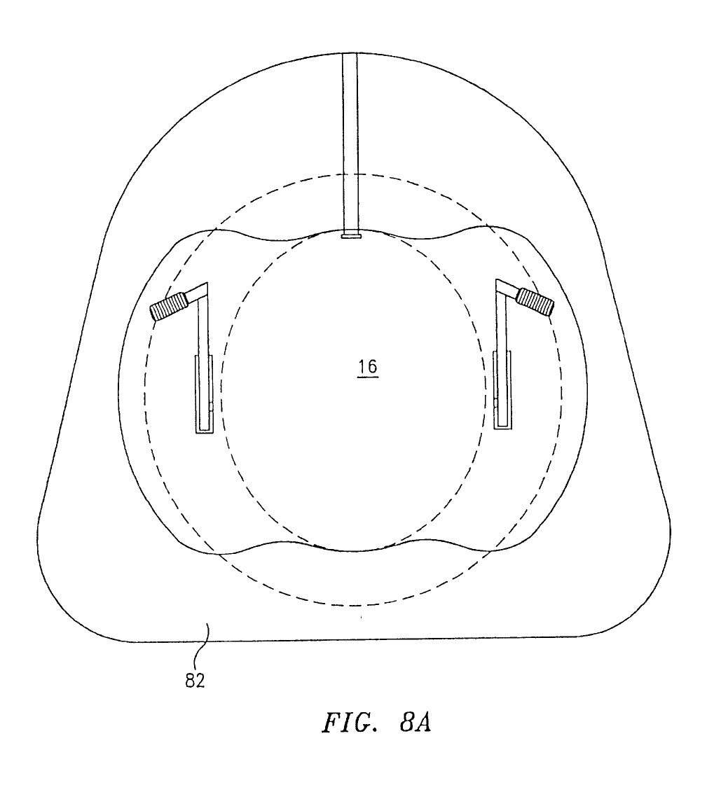

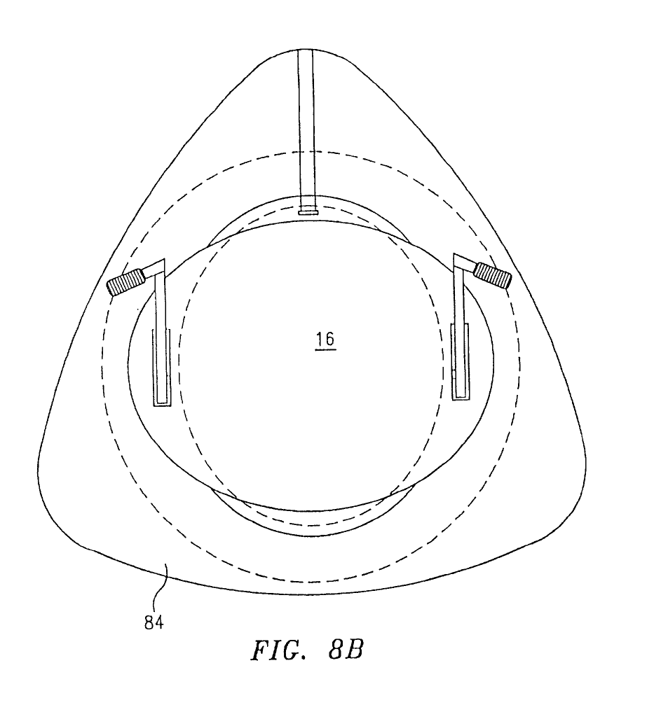

While the ski vehicle of the present invention has been generally illustrated as comprising a toroidal bladder and round ski insert, the ski vehicle could be other shapes instead. For example, FIGS. 8A and 8B show the ski vehicle with delta- or triangle-shaped bladders 82, 84. This prevents the ski vehicle from rolling out of control along its circumferential side edge, as could possibly happen if a user fell off the ski vehicle and it was somehow upended. The delta-shaped bladders 82, 84 have round central openings for accommodating the contoured insert 16. Also, while the delta-shaped bladders 82, 84 are generally triangular in outline, they are still largely toroidal or tubular, i.e., they have a rounded, annular topside and bottom side. This facilitates mobility, and allows the ski vehicle to be pivoted over its center during turning, as discussed above.

Other shapes are possible besides a delta-shaped bladder with a round central opening, or a round toroidal bladder. For example, the delta-shaped bladders 82, 84 could have a triangular central opening, to which the insert would be correspondingly configured, or it could have a central opening with some other shape. Also, the bladder and/or ski insert could be oblong or oval-shaped, polyhedral, rounded square-shaped, etc. Further, as should be appreciated, the bladder does not necessarily have to exactly match the ski insert, since the bladder, being somewhat flexible, will tend to conform to the shape of the ski insert.

Although the ski insert portions of the ski vehicle of the present invention have been illustrated as being made of thermoplastic or other polymers, one of ordinary skill in the art will appreciate that the ski inserts could be made of other materials instead, without departing from the spirit and scope of the invention. For example, the ski inserts could be made out of metal or wood.

Although the ski vehicle of the present invention has been illustrated as having two parallel runners, one of ordinary skill in the art will appreciate that a single central runner could be provided instead without departing from the spirit and scope of the invention.

Although the ski vehicle of the present invention has been illustrated as having external biasing springs for the lever arms, it should be appreciated that the springs could be internal to the ski vehicle. For example, the springs could be torsion springs operably and concentrically disposed over the pivot shafts 35.

Since certain changes may be made in the above described inflatable tube ski vehicle with steering mechanism, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Having thus described the invention, what is claimed is:

1. A ski vehicle comprising:
a. an inflatable bladder having a central opening;
b. a ski insert disposed in the central opening; and
c. left and right lever arms pivotally attached to the ski insert and extending through the central opening of the bladder; wherein the lever arms can be moved to a retracted position, wherein ends of the lever arms lie proximate a bottom of the ski insert, and to a deployed position, wherein the ends of the lever arms lie away from the bottom of the ski insert; whereby for steering or braking, one or both of the lever arms are moved to the deployed position, with the ends of the levers being thereby positioned to interfere with passing snow.

2. The ski vehicle of claim 1 wherein the bladder is delta-shaped.

3. The ski vehicle of claim 1 wherein:
a. the bottom of the ski insert has an upwardly curved outer annular portion whose outer edge abuts the bladder; and
b. the ski insert further comprises a concave side wall connected to the outer edge of the outer annular portion of the bottom and extending up through the central opening of the bladder, said concave side wall being configured to fit against the bladder.

4. The ski vehicle of claim 1 wherein:
a. the bottom of the ski insert has an upwardly curved outer annular portion whose outer edge abuts the bladder; and
b. the ski insert further comprises left and right side wings connected to the bottom and extending up through the central opening of the bladder to pass partially over the top of the bladder and each defining an outwardly-facing, concave surface that fits against the bladder.

5. The ski vehicle of claim 1 wherein:
a. the bladder is delta-shaped;
b. the bottom of the ski insert has an upwardly curved outer annular portion whose outer edge abuts the bladder; and
c. the ski insert further comprises left and right side wings connected to the bottom and extending up through the central opening of the bladder to pass partially over the top of the bladder and each defining an outwardly-facing, concave surface that fits against the bladder.

6. The ski vehicle of claim 1 wherein:
a. the bottom of the ski insert has an upwardly curved outer annular portion whose outer edge abuts the bladder; and
b. the ski insert further comprises:
i. an upper portion extending up from the bottom and having a contoured top surface configured for use as a seat; and
ii. left and right side wings extending outwards from the upper portion and bottom, said side wings extending partially over the top of the bladder and each defining an outwardly-facing, concave surface that fits against the bladder.

7. A ski vehicle comprising:
a. an inflated bladder having a central opening;
b. a ski insert positioned in the central opening and connected to the bladder, said ski insert having: a top side; a bottom side; and first and second side openings extending through the ski insert; and
c. first and second lever arms pivotally attached to the ski insert and extending through the central opening of the bladder and through the first and second side openings, respectively, said first and second lever arms each having an upper portion extending past the top side of the ski insert and a lower portion proximate the bottom side of the ski insert, wherein the first and second lever arms can be pivoted to vary the position of the lower portions of the lever arms relative to the bottom of the ski insert, for steering and/or braking.

8. The ski vehicle of claim 7 wherein the bladder is delta-shaped.

9. The ski vehicle of claim 7 wherein:
a. the bottom side of the ski insert has an upwardly curved outer annular portion whose outer edge abuts the bladder; and
b. the top side and bottom side of the ski insert are connected via an outwardly-facing, concave surface that fits against the bladder.

10. The ski vehicle of claim 7 wherein:
a. the bladder is delta-shaped;
b. the bottom side of the ski insert has an upwardly curved outer annular portion whose outer edge abuts the bladder; and
c. the top side and bottom side of the ski insert are connected via an outwardly-facing, concave surface that fits against the bladder.

11. The ski vehicle of claim 7 wherein:
a. the bottom side of the ski insert has an upwardly curved outer annular portion whose outer edge abuts the bladder;
b. the top side of the ski insert is contoured for use as a seat; and
c. the top side and bottom side of the ski insert are connected by way of left and right side wings extending partially over the top of the bladder and each defining an outwardly-facing, concave surface that fits against the bladder.

12. A ski vehicle comprising:
a. an inflatable bladder having a central opening;
b. a ski insert positioned in the central opening and abutting the bladder, said ski insert having a top side, a bottom side, and first and second side openings extending through the ski insert; and
c. first and second lever arms pivotally attached to the ski insert and extending through the central opening of the bladder and through the first and second side openings, respectively, wherein the first and second lever arms can be pivoted to vary the extent to which bottom ends of the lever arms extend beyond the bottom side of the ski insert.

13. A ski vehicle comprising:
a. an inflatable delta-shaped bladder having a central opening;
b. a ski insert positioned in the central opening and abutting the bladder, said ski insert having: a top side; a bottom side with an upwardly curved outer annular portion whose outer edge abuts the bladder; and first and second side openings extending through the ski insert, said tope and bottom sides being connected via a concave side wall configured to fit against the bladder; and
c. first and second lever arms pivotally attached to the ski insert and extending through the central opening of the bladder and through the first and second side openings, respectively, wherein the first and second lever arms can be pivoted to vary the extent to which first and second snow rakes, attached to bottom ends of the first and second lever arms, respectively, extend beyond the bottom side of the ski insert.
